(19) United States
(12) Patent Application Publication
(10) Pub. No.: US 2009/0129754 A1
(43) Pub. Date: May 21, 2009

(54) Recording/reproducing device recommending preferable operation

(75) Inventors: Kenichiro Tada, Saitama (JP); Yuji Shimizu, Saitama (JP)

Correspondence Address: YOUNG & THOMPSON, 209 Madison Street, Suite 500, ALEXANDRIA, VA, 22314, US

(73) Assignee: PIONEER CORPORATION, TOKYO (JP)

(21) Appl. No.: 11/921,015

(22) PCT Filed: May 25, 2006
(86) PCT No.: PCT/JP2006/310445

§ 371 Date: Nov. 26, 2007

(30) Foreign Application Priority Data
May 25, 2005 (JP) 2005-153001

(51) Int. Cl. H04N 7/26

(52) U.S. Cl. 386/124; 386/E05.001

(57) ABSTRACT

A recording/reproducing device includes: attribute information storage for storing attribute information on content information to be recorded; operation history storage for storing operation history information indicating a history of a decision operation of the recording mode by a user; a recommendation element for specifying a preferable recording mode according to the attribute information and the operation history information on the preceding content information before recording the content information and recommending the recording mode to a user; first recording element for recording the content information on a first recording medium at the decided recording mode; second recording element for recording from the first recording medium to a second recording medium at the recording mode at which the content information has been decided; and reproducing element for reproducing the content information.

### TECHNICAL FIELD

The present invention relates to a recording/reproducing apparatus which can record or reproduce the content information of a broadcast program or the like onto an information recording medium, such as a Hard Disk, an already widespread or normal DVD (hereinafter simply referred to as a “DVD”), and a next-generation Blu ray disc (hereinafter simply referred to as a “Blu-ray disc”).

### BACKGROUND ART

Recently, a broadcast form or the content information has become diversified. At the same time, recording media for recording the content information thereon have also become diversified. As a result, the combination of the input source and the output destination of the content information has become diversified. As the input source, there are, for example, broadcast, such as territorial analog broadcast, BS (Broadcast Satellite) analog broadcast, BS/CS (Communication Satellite) digital broadcast, and terrestrial digital broadcast, and a data communication port, such as IEEE (Institute of Electrical and Electronic Engineers) 1394 standard. As the output destination, there are, for example, a DVD-Video, a DVD-VR (DVD Video recording), and a Blu-ray disc. When the content information from the input source is recorded onto a recording medium as the output destination, generally, it is temporarily recorded onto a hard disk. At this time, the combination of the input source and the output destination needs to be selected by a user in view of restrictions, such as a different in the format between the input source and the output destination, and copyright restrictions. For example, if compatibility is valued, it is better to select the DVD-Video and the DVD-VR, which are already widespread, as the output destination. However, if the input source is, for example, digital broadcast, the format needs to be converted, and there is no choice but to deteriorate image quality. If the image quality is valued, it is necessary to select the Blu-ray disc as the input destination, which can perform the recording in a MPEG-TS (Transport Stream) format. Moreover, the content information of the terrestrial digital broadcast cannot be recorded onto the DVD-Video because of the copyright restrictions, such as copy once.

It has been becoming difficult for the user to select and operate what is suitable for the user from the various combinations of the content information, as described above. In addition, if the output destination is not appropriate, there is such a disadvantage that reformatting is necessary, for example.

Thus, there are suggested various technologies for reducing a user's operation load or for allowing a preferable operation.

For example, in a patent document 1, there is suggested a technology about mutual conversion between a MPEG-TG format and a MPEG-PS (Program Stream) format. In a patent document 2, there is suggested a technology about mutual conversion in the format between a DVD Video method and a DVD Video recording method. In a patent document 3, there is suggested a technology in which the content information is automatically recorded in accordance with user's complicated and various preferences, on the basis of the user's various operations.

Patent document 1: Japanese Patent Application Laid Open NO. 2003-111023
Patent document 2: Japanese Patent Application Laid Open NO. 2003-153170
Patent document 3: Japanese Patent Application Laid Open NO. 2004-72502

### DISCLOSURE OF INVENTION

### Subject to be Solved by the Invention

In the aforementioned patent documents 1 to 3, the attribute of the content information, such as analog broadcast and digital broadcast, and the type of the recording medium, such as a hard disk, a DVD, and a Blu-ray disc, are not considered. Thus, a user cannot select the preferable recording medium according to the attribute of the content information.

In order to solve the above-exemplified problems, it is therefore an object of the present invention to provide a recording/reproducing apparatus which can recommend a preferable operation according to the attribute of the content information to a user when the content information is recorded

### Means for Solving the Object

(Recording/Reproducing Apparatus)

The above object of the present invention can be achieved by a first recording/reproducing apparatus provided with: an attribute information memory device for storing attribute information which indicates an attribute corresponding to i-th content information to be recorded (wherein i is a natural number); an operation history memory device for storing operation history information which indicates a history of determination operations related to a user's determination of a recording mode, which is performed on the i-th content information; a recommending device for specifying a recording mode, which is preferable for the user, of the i-th content information and recommending the specified recording mode to the user, on the basis of the attribute information and the operation history information related to the (i−1)-th and previous content information before the i-th content information is recorded; a first recording device for recording the i-th content information onto the first recording medium in the recording mode determined by the determination operation by the user in accordance with or against the recommended recording mode; a second recording device for recording the recorded content information in the determined recording mode from the first recording medium to the second recording medium; and a reproducing device for reproducing the content information recorded on the first or second recording medium.

According to the first recording/reproducing apparatus in the present invention, in its operation, firstly, the i-th content information of a broadcast program, such as news, sports, drama series, and documentary, is inputted by an inputting device, such as a tuner for receiving broadcast, such as terrestrial analog broadcast, BS analog broadcast, BS/CS digital broadcast, and terrestrial digital broadcast, or a data communication port like the IEEE 1394 standard.

The i-th content information inputted in this manner is recorded by the first recording device onto the first recording medium, such as a hard disk, in accordance with the user's operation. That is, it is recorded in some recording mode. After that, it is recorded (e.g. dubbed, copied, moved, etc.) by the second recording device onto the second recording medium, such as a DVD-Video, a DVD-VR, and a Blu-ray disc. Moreover, the content information recorded on the first recording medium or the second recording medium is reproduced by the reproducing device in accordance with the user's operation.

In the present invention, in particular, out of such a series of user's operations, at least the determination operation associated with the determination of the recording mode is stored by the operation history memory device provided with a memory or the like, as the operation history information which indicates a history of the user's operation. As the stored user's operation history information, there is, for example, the setting of the recording mode. In the recording mode setting, the type of the second recording medium, such as a DVD-VR and a Blu-ray disc, and the image quality, such as FINE (highest image quality) and SP (standard image quality), and the like are set when the i-th content information is recorded from the first recording medium to the second recording medium. Alternatively, in the recording mode setting, the type, image quality, and the like of the second recording medium in the recording onto the second recording medium, which is intended to be performed by the user later or which is possibly performed, are set before the recording onto the first recording medium, i.e. in advance. Alternatively, in the recording mode setting, the image quality and the like in the recording onto the first recording medium may be set immediately before the recording operation. In any case, the recording is performed on the second recording medium in the set recording mode. Preferably, the recording is performed on the second recording medium in the same recording mode as that in the recording onto the first recording medium. As described above, if the recording is performed in the same recording mode, the recording mode set for the first recording medium is the recording mode set for the second recording medium. Incidentally, at least the recording mode setting on the first recording medium can be performed before the actual recording; namely, recording reservation or programmed recording is possible.

Moreover, what is stored as the operation history information is the user's operation performed when the i-th content information is recorded or when the i-th content information is reproduced or further recorded (i.e. copied, dubbed, moved, etc.).

On the other hand, the attribute information which indicates the attribute corresponding to the attribute of the i-th content information is stored by the attribute information memory device provided with a memory or the like. What are stored as the stored attribute information are, for example, the type of broadcast, such as terrestrial analog broadcast, BS analog broadcast, BS/CS digital broadcast, and terrestrial digital broadcast, i.e. the type of a carrier wave of carrying the content information, the genre or the like of the content information, such as sports programs, movies, drama, news, documentary, and music programs, and the like. Moreover, a group of the carrier wave type and the genre may be treated as one attribute, such as a BS digital broadcast movie, a terrestrial analog broadcast drama, and a CS digital broadcast music program. Incidentally, the “attribute information” may or may not be added to the content information. For example, it may be inputted through a communication device and an input device separately from the content information. Alternatively, it may be detected from the type, format, and the like of the carrier wave of carrying the content information.

Here, in particular, before the i-th content information is recorded, the preferable recording mode, which is preferable for the user, of the i-th content information is specified by the recommending device, on the basis of the attribute information and the operation history information associated with the (i−1)-th and previous content information (i.e. prior to the i-th information, including the (i−1)-th information). Then, the recording mode specified in this manner is recommended by the recommending device to the user in the recording reservation, for example. Here, “to recommend” means to visually or aurally provide information which induces the use of the specified recording mode, for the user by using a display screen and a speaker, for example. Moreover, the term “preferable” means that it is suitable for the user's preference and that it is suitable in the relation between the attribute corresponding to the content information and the second recording medium. With regard to the user's preference, out of the user's operation history recorded in the operation history information regarding the content information with the same attribute, such as a movie broadcast in CS digital broadcast (or sports in terrestrial analog), an operation which is performed many times, e.g. an operation of always selecting a particular type of second recording medium or a particular recording mode is the operation that the user prefers, and it may be judged to be preferable for the user.

Incidentally, with regard to the relation between the attribute corresponding to the content information and the second recording medium, the user may judge that the second recording medium which does not need downconverting is preferable or that the second recording medium which needs downconverting but provides high compatibility is preferable.

In accordance with or against the recording mode recommended in this manner, the user determines the recording mode and performs the determination operation. The determination operation is stored by the operation history memory device as the operation history information, as described above, and it is used when the recording mode of the next, i.e. (i+1)-th content information is recommended.

Consequently, the larger number of times the user performs the operation, i.e. the more frequently the user uses the recording/reproducing apparatus of the present invention, the more preferable, based on the user, recording mode of the content information can be recommended. The user does not have to set the recording mode of the content information in each time of recording from the beginning. That is, the operation of setting the recording mode is hardly performed or a load related to the setting operation is reduced, in accordance with the recommendation by the recommending device. In this manner, usability increases, and it is possible to reduce the user's operation load like that the recording mode is to be changed every time by the user's operation. At this time, in particular, the recording onto the first recording medium is performed in the recording mode that is eventually the same as that in the recording (i.e. copy, dubbing, move, etc.) onto the second recording medium, which is expected to be performed later. Thus, the format conversion is unnecessary in the recording. Thus, high-speed processing becomes possible when the recording is performed from the first recording medium to the second recording medium, which reduces a time required for the recording. For example, if the format conversion is necessary when the recording is performed from the first recording medium to the second recording medium, a one-time speed to a several-time speed are the limit of high-speed processing; however, if the format conversion is unnecessary, a several-ten-time speed of high-speed processing is possible.

In one aspect of the first recording/reproducing apparatus of the present invention, the recommending device specifies the preferable recording mode in each attribute.

According to this aspect, the preferable recording mode is specified by the recommending device in each attribute. Thus, the content information can be recorded in the preferable recording mode according to the attribute. For example, if the content information is obtained from a HD broadcast in terrestrial digital broadcast, the preferable recording mode is set on the basis of the fact that a Blu-ray disc, which does not need the format conversion in the recording, is preferable as the second recording medium. At this time, high-speed processing becomes possible when the recording is performed from the first recording medium to the second recording medium in the specified recording mode, which reduces a time required for the recording. Moreover, high-definition video images by the HD broadcast can be recorded.

As described above, by that the preferable recording mode is specified by the recommending device in each attribute, the user can record the content information in the preferable recording mode according to the attribute of the content information. In other words, the user's preference for the recording mode depends more or less on the attribute of the content information, so that this aspect is extremely useful in practice.

In another aspect of the first recording/reproducing apparatus of the present invention, the recommending device specifies the recording mode which is relatively highly frequently determined in the determination operations, as the preferable recording mode in each attribute.

According to this aspect, under the premise that the more strongly the user prefers a certain recording mode in each attribute, the more frequently the recording mode is determined, the recording mode which is relatively highly frequently determined by the user in each attribute in the determination operations in the recording reservation is specified by the recommending device as the preferable recording mode. For example, in the recording reservation, if such a determination operation that a DVD-VR is set as the second recording medium and FINE is set as the image quality with respect to the content information in the terrestrial digital broadcast is relatively frequently performed in the determination operation by the user, this recording mode is specified by the recommending device as the preferable recording mode for the user. Then, in the recording reservation, as the preferable recording mode with respect to the content information in the terrestrial digital broadcast, the DVD-VR as the second recording medium and FINE as the image quality are respectively recommended by the recommending device. Thus, the user does not have to perform the operation of respectively setting the DVD-VR as the second recording medium and FINE as the image quality when the terrestrial digital broadcast is recorded. Thus, it is possible to recommend the recording mode suitable for the user's preference in the recording reservation, and further reduce the user's operation load.

In another aspect of the first recording/reproducing apparatus of the present invention, the recommending device specifies the recording mode which is relatively highly frequently determined in the determination operations which were performed the predetermined number of times in the past from the i-th determination operation, as the preferable recording mode.

According to this aspect, the recording mode, which is relatively highly frequently determined in the determination operations which were performed the predetermined number of times in the past from the i-th determination operation, is specified by the recommending device as the preferable recording mode. Thus, the recording mode suitable for the user's latest preference can be specified as the preferable recording mode. For example, the recording mode which is relatively highly frequently determined in the determination operations which were performed ten times in the past from the i-th determination operation is considered to be the preferable recording mode. Thus, regardless of the determination operation that the user preferably performed before the ten times of operations, it is possible to specify the recording mode suitable for the user's preference in the last ten times of determination operations. That is, the recording mode suitable for the user's preference, which can be changed with the course of time, can be set as the preferable recording mode. Thus, the recording mode preferable for the user can be recommended to the user, almost certainly. Incidentally, the predetermined number of times which goes back to the past may be set any number as long as a memory or the like provided for the operation history memory device allows it. However, it is preferably set to the last ten times or so in order to reflect the user's latest preference.

Moreover, when the recording mode which is relatively frequently determined in the determination operations, such a determination operation that indicates the preference opposite to the user's preference, such as an unperformed operation over a certain period, may be considered. That is, if certain content information is unoperated over a certain period or deleted, it may be judged that the recording in the recording mode becomes not suitable for the user's preference or it is not necessary any more, and the frequency of the determination operation may be reduced.

In addition, the recording mode which is relatively highly determined in the determination operation may be specified as the preferable recording mode, in the determination operations in a predetermined period, such as 1 month, 3 months, and 6 months, instead of the predetermined number of times.

In another aspect of the first recording/reproducing apparatus of the present invention, the recommending device includes a score adding device for adding a score which indicates degrees of preferableness it is for the user, to at least one of the attribute information and the operation history information.

According to this aspect, if the determination operation associated with the user's determination of the recording mode is performed, the score, which indicates degrees of preferableness it is for the user, is added by the score adding device to at least one of the attribute information and the operation history information of the content information which is a target of the determination operation. For example, under the premise that the more strongly the user prefers a certain recording mode, the more frequently the recording mode is determined, the score is added to the attribute information in accordance with the number of times that the recording mode is determined. Alternatively, under the premise that the more weakly the user prefers a certain recording mode, the less frequently the content information recorded in the recording mode is further recorded (i.e. copied, dubbed, moved, etc.) or the more frequently it is deleted, the score may be added to the attribute information in accordance with the number of the content information that is not further recorded later over a certain period or that is deleted. Alternatively, under the premise that the more strongly the user prefers a certain recording mode, the more frequently the content information recorded in the recording mode is further recorded later, the score may be added to the attribute information in accordance with the number of times that the content information that is further recorded later.

The score added in this manner reflects the user's preference. Thus, the recording mode suited for the user's preference on the basis of the score can be recommended by the recommending device.

In another aspect of the first recording/reproducing apparatus of the present invention, it is further provided with a determining device which can determine the recording mode through the determination operations by the user, the first recording device recording the i-th content information onto the first recording medium in the recording mode determined through the determining device, the second recording device recording the i-th content information onto the second recording medium in the recording mode determined through the determining device.

According to this aspect, for example, if the determination operation is performed on a recording reservation setting screen by the user, the recording mode according to this is determined through the determining device, such as a remote controller, an operation panel, and an audio inputting device. The i-th content information is recorded onto the first recording medium by the first recording device in the determined recording mode. After that, the i-th content information is recorded (e.g. dubbed, copied, moved, etc.) by the second recording device in the same recording mode from the first recording medium to the second recording medium. Thus, the determination operation of determining the recording mode by the user, which reflects the recommendation by the recommending device, can be realized in an easy operation.

In another aspect of the first recording/reproducing apparatus of the present invention, the attribute information memory device stores an input form of the inputted content information, as the attribute information.

According to this aspect, the input form, such as a data communication port type like the IEEE 1394 standard and a broadcast type like terrestrial analog broadcast, BS analog broadcast, BS/CS digital broadcast, terrestrial digital broadcast and the like, is stored by the attribute information memory device as the attribute information.

Thus, before the recording onto the first recording medium, such as a hard disk, i.e. before temporal accumulation, it is possible to specify the recording mode according to restrictions about e.g. copyright and a data format which depend on the input form of the content information.

In another aspect of the first recording/reproducing apparatus of the present invention, the attribute information memory device stores genre to which the inputted content information belongs, as the attribute information.

According to this aspect, the attribute information memory device stores the genre of the content information, such as a sports program, movie broadcast, drama, news, documentary, and a music program, as the attribute information. Thus, it is possible to recommend the recording mode that the user prefers in each genre.

In another aspect of the first recording/reproducing apparatus of the present invention, the operation history memory device stores a change operation of the recommended recording mode, as the operation history information.

According to this aspect, if the recommended recording mode is changed by the user, i.e. if the change operation is performed, the change operation is stored by the operation history memory device as the operation history information. Then, under the premise that the more frequently a certain recording mode is set after the change operation, the more suitable the recording mode is for the user's preference, the recording mode that is frequently set after the change operation is specified as the preferable recording mode. Thus, it is possible to recommend the recording mode according to the user's preference, and it is possible to reduce the user's operation load like that the recording mode is to be changed many times by the user's change operation.

The above object of the present invention can be achieved by a second recording/reproducing apparatus on which content information recorded on a first recording medium can be recorded in a desired recording mode by a second recording device which can perform recording from the first recording medium to a second recording medium, the recording/reproducing apparatus provided with: an attribute information memory device for storing attribute information which indicates an attribute corresponding to i-th content information to be recorded (wherein i is a natural number); an operation history memory device for storing operation history information which indicates a history of determination operations related to a user's determination of a recording mode, which is performed on the i-th content information; a recommending device for specifying a recording mode of the i-th content information, which is preferable for the user, and recommending the specified recording mode to the user, on the basis of the attribute information and the operation history information related to the (i−1)-th and previous content information before the i-th content information is recorded; a first recording device for recording the i-th content information onto the first recording medium in the recording mode determined by the determination operation by the user in accordance with or against the recommended recording mode; and a reproducing device for reproducing the content information recorded on the first recording medium.

According to the second recording/reproducing apparatus of the present invention, the second recording device, such as a DVD recorder, is externally mounted or wirelessly connected or the like. That is, the second recording/reproducing apparatus is an apparatus which can provide the content information recorded once on the first recording device, to the second recording device which is externally mounted or the like. Thus, as in the aforementioned first recording/reproducing apparatus of the present invention, the larger number of times the user performs the operation, the more preferable recording mode of the content information can be recommended in each recording reservation. In particular, as long as the second recording device, which is externally mounted or the like, is not changed, the recommendation of the recording mode remains valid, and the same operation effect as that of the first recording/reproducing apparatus can be obtained. Even if the second recording device, which is externally mounted or the like, is changed (e.g. even if the connected second recording device is changed from a DVD recorder to a Blu-ray disc recorder), as it continues to be used, the history information is changed, and the recommended recording mode is also changed to a mode suitable for the second recording device after the change. However, the history information may be reset when the second recording device, which is externally mounted or the like, is changed.

These effects and other advantages of the present invention will become more apparent from the following embodiments.

As explained above, the first and second recording/reproducing apparatus is provided with the recommending device which specifies the preferable recording mode for the user on the basis of the attribute information and the operation history information and which recommends the specified recording mode to the user. Thus, high-speed processing is possible when the recording is performed from the first recording medium to the second recording medium, which reduces a time required for the recording.

### BRIEF DESCRIPTION OF DRAWINGS

FIG. 1 is a block diagram showing the basic structure of a recording/reproducing apparatus in a first embodiment.

FIG. 2 is a table showing a relationship between attribute information and operation history information in an initial state.

FIG. 3 is a table having the same concept as that of FIG. 2 after a plurality of times of user's operations are performed.

FIG. 4 is a table having the same concept as that of FIG. 3 after a plurality of times of user's operations are further performed from the condition in FIG. 3.

FIG. 5 is a table showing the operation history information corresponding to FIG. 3, in terrestrial digital broadcast.

FIG. 6 is a table showing the operation history information corresponding to FIG. 4, in the terrestrial digital broadcast.

FIG. 7 is a flowchart showing a change in the operation history information associated with a recording mode setting change.

FIG. 8 is a flowchart showing a change in the operation history information associated with deletion of the content information, dubbing, move, etc. and an unperformed operation over a certain period.

FIG. 9 is a flowchart showing a flow of specification of a recommendation recording mode.

FIG. 10 is a diagram showing image quality setting types.

FIG. 11 is a schematic diagram showing a recording reservation screen when the terrestrial digital broadcast is recorded in the condition of FIG. 2.

FIG. 12 is a schematic diagram having the same concept as that of FIG. 11 in the condition of FIG. 3.

FIG. 13 is a table having the same concept as that of FIG. 3 in a second embodiment.

### DESCRIPTION OF REFERENCE CODES

110 first recording device
111 first recording medium
120 second recording device
121 second recording medium
141 attribute information memory device
142 operation history memory device
150 recommendation device
152 score addition device
160 reproduction device

### BEST MODE FOR CARRYING OUT THE INVENTION

Hereinafter, the best mode for carrying out the present invention will be explained in each embodiment in order with reference to the drawings.

### First Embodiment

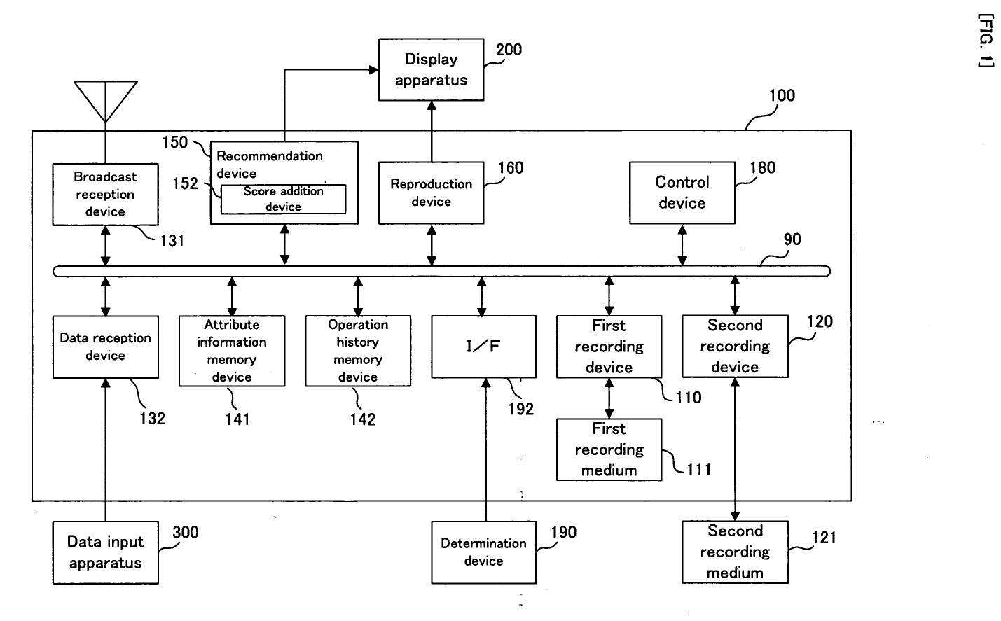

Firstly, with reference to FIG. 1 to FIG. 12, a recording/reproducing apparatus in a first embodiment of the present invention will be explained.

(1-1) Basic Structure

Firstly, with reference to FIG. 1, the basic structure of the recording/reproducing apparatus in the first embodiment of the present invention will be explained. FIG. 1 is a block diagram showing the basic structure of the recording/reproducing apparatus in the first embodiment of the present invention.

As shown in FIG. 1, a recording/reproducing apparatus 100 is provided with: a broadcast reception device 131; a data reception device 132; an attribute information memory device 141; an operation history memory device 142; a recommendation device 150; a reproduction device 160; a determination device 190; a determination interface (I/F) 192; a first recording device 110; a first recording medium 111; a second recording device 120; and a control device 180.

From among these constituent elements, the broadcast reception device 131, the data reception device 132, the attribute information memory device 141, the operation history memory device 142, the recommendation device 150, the reproduction device 160, the determination interface (I/F) 192, the first recording device 110, the second recording device 120, and the control device 180 are connected through a system bus 90.

The broadcast reception device 131 receives the content information from broadcast, such as terrestrial analog broadcast, BS analog broadcast, BS/CS digital broadcast, and terrestrial digital broadcast.

The data reception device 132 receives the content information from a data input apparatus 300 which complies with a data communication standard, such as the IEEE 1394 standard.

The attribute information memory device 141 is formed of a memory or the like. As described later, the attribute information memory device 141 stores therein attribute information which indicates an attribute corresponding to the content information to be recorded.

The operation history memory device 142 is formed of a memory or the like. As described later, the operation history memory device 142 stores therein operation history information which indicates a determination operation history associated with user's determination of a recording mode performed on the content information.

The determination device 190 is, for example, a remote controller, an operation panel, an audio input device, or the like. The operation performed by a user on the determination device 190 is inputted into the recording/reproducing apparatus 100 through the determination interface 192.

The first recording device 110 is a hard disk drive, and it can record the content information onto the first recording medium 111, which is a hard disk.

The second recording device 120 is a removable disc drive, and it can record the content information onto the second recording medium 121 of a plurality of types, which are a DVD-Video, a DVD-VR, a Blu-ray disc, and the like.

The reproduction device 160 reproduces the content information recorded on the first recording medium 111 or the second recording medium 121. The reproduced content information is displayed on an external display apparatus 200.

The recommendation device 150 includes a score addition device 152 for adding a score, which indicates the degree of preferableness it is (or how much it is preferable) for the user, to at least one of the attribute information and the operation history information, to thereby specify a preferable recording mode, as described later. The specified recording mode is displayed, e.g., on the external display apparatus 200.

The control device 180 integrally controls the constituent elements which constitutes the recording/reproducing apparatus 100.

(1-2) Operation Principle

(1-2-1) Basic Operation

Next, with reference to FIG. 1, an explanation will be given on the basic operation of the recording/reproducing apparatus in the first embodiment of the present invention.

In FIG. 1, in the operation of the recording/reproducing apparatus 100, firstly, the i-th content information (wherein i is a natural number) of a broadcast program, such as news, sports, drama series, and documentary, is inputted through the broadcast reception device 131 or the data reception device 132.

The i-th content information inputted in this manner is recorded by the first recording device 110 onto the first recording medium 111 in accordance with the user's operation. That is, it is recorded in some recording mode. After that, it is recorded (e.g. copied, dubbed, moved, and the like) by the second recording device 120 onto the second recording medium 121. Moreover, the content information recorded on the first recording medium 111 or the second recording medium 121 is reproduced on the display apparatus 200 by the reproduction device 160 in accordance with the user's operation.

Now, resolution and image quality in the embodiment will be explained. The resolution of video images includes HD and SD. The HD is high definition or high resolution, represented by 1920×1080 pixels. The SD is standard definition or standard resolution (720×480). Moreover, it is known that the video image quality is closely related to a bit rate, and there is an item of setting an image quality parameter depending on products.

Now, the parameter of the recording mode in the embodiment will be explained. With regard to the recording mode, there are a recording mode DR in which the recording is performed with a transmission-side parameter of the digital broadcast and a recording mode SD in which the digital broadcast is decoded in the own device and encoded again or transcoded, or in which analog broadcast is encoded. Moreover, if the recording mode is SD, the image quality can be specified, and the parameter, which indicates the image quality, includes FINE, SP, LP, and EP. These are sequenced by the size of a video bit rate. FINE means recording at a video bit rate of about 9 Mbps. SP means recording at a video bit rate of about 4.5 Mbps. LP means recording at a video bit rate of about 2 Mbps. EP means recording at a video bit rate of about 1 Mbps.

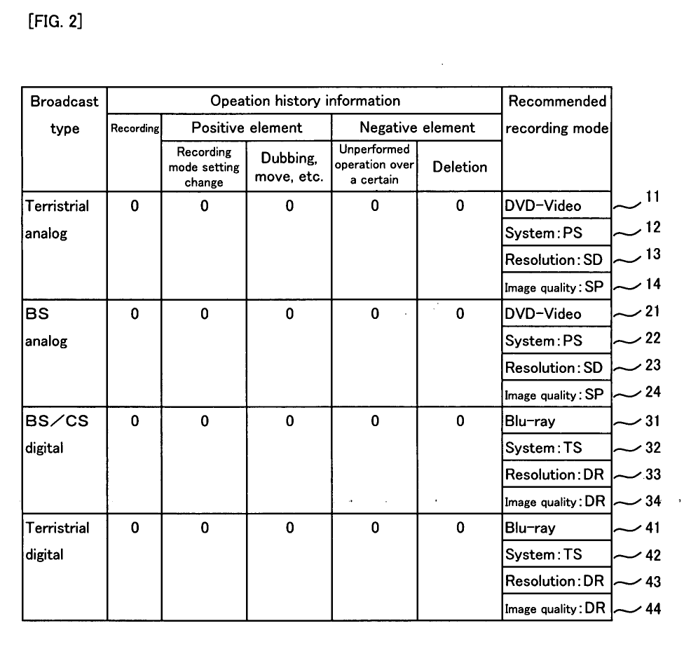

Incidentally, “DR” as the recording mode is a mode of recording at the resolution and the bit rate (i.e. image quality) which are encoding results on the transmission side when the digital broadcast is recorded, as described above. That is, the recording mode “DR” does not separately and independently set the resolution and the bit rate (i.e. image quality). In the embodiment, for convenience of explanation, if “DR” is selected as the recording mode, the explanation will be given under the assumption that each of the resolution and the image quality is set to “DR”. For example, in FIG. 2, in order to show that “DR” is selected as the recording mode, an item 43 associated with the resolution is set to “DR”, and an item 44 associated with the image quality is set to “DR”. That is, such a situation that only either one of the item associated with the resolution and the item associated with the image quality is set to “DR” does not happen. Incidentally, the parameter associated with the image quality is valid only in the recording mode “SD”. For example, in FIG. 2, if “DR” is specified in the column of resolution, there is no setting in the image quality.

(1-2-2) Storage of Operation History Information and Attribute Information

In FIG. 1, particularly in the embodiment, out of such a series of user's operations, at least a determination operation associated with the determination of the recording mode is stored, as the operation history information which indicates the user's operation history, by the operation history memory device 142. As the stored user's operation history information, there is the setting of the recording mode, for example.

In the recording mode setting, the type of the second recording medium 121, such as a DVD-VR and a Blu-ray disc, and the image quality, such as FINE (highest image quality) and SP (standard image quality), and the like are set when the i-th content information is recorded from the first recording medium 111 to the second recording medium 121. Alternatively, in the recording mode setting, the type, image quality, and the like of the second recording medium 121 in the recording onto the second recording medium 121, which is intended to be performed by the user later or which is possibly performed, are set before the recording onto the first recording medium 111, i.e. in advance. Alternatively, in the recording mode setting, the image quality and the like in the recording onto the first recording medium 111 may be set immediately before the recording operation. In a typical case, in accordance with specifications or functions of the recording/reproducing apparatus, at least the type, resolution, and image quality of the second recording medium 121 are set as required parameters when the recording mode is determined. Then, the recording is performed on the second recording medium 121 in the recording mode set as a combination of these parameters. Incidentally, in addition to these required parameters, another parameter in the recording, such as a parameter for specifying an audio mode of monaural, stereo, bilingual, and the like, may be arbitrarily determined. Moreover, even if the required parameters are not specified by the user, each of the required parameters may be set to a default value determined in advance. In this case, the specification of the required parameters by the user can be omitted from the beginning of the use. Then, preferably, the recording is performed on the second recording medium 121 in the same recording mode as that in the recording onto the first recording medium 111. If the recording is performed in the same recording mode, the recording mode set for the first recording medium 111 is the recording mode set for the second recording medium 121. Incidentally, at least the recording mode setting on the first recording medium 111 can be performed before the actual recording; namely, recording reservation or programmed recording is possible.

Moreover, what is stored as the operation history information is the user's operation performed when the i-th content information is recorded or when the i-th content information is reproduced or further recorded (i.e. copied, dubbed, moved, and the like).

On the other hand, the attribute information which indicates the attribute corresponding to the attribute of the i-th content information is stored by the attribute information memory device 141. In the embodiment, as the attribute information, the type of broadcast, such as terrestrial analog broadcast, BS analog broadcast, BS/CS digital broadcast, and terrestrial digital broadcast, i.e. the type of a carrier wave of carrying the content information, is stored. Incidentally, as the attribute information, the genre or the like of the content information may be stored, such as sports programs, movies, drama, news, documentary, and music programs. Moreover, a group of the carrier wave type and the genre may be treated as one attribute, such as a BS digital broadcast movie, a terrestrial analog broadcast drama, and a CS digital broadcast music program. Incidentally, the “attribute information” may or may not be added to the content information. For example, it may be inputted through a communication device and an input device, separately from the content information. Alternatively, it may be detected from the type, format, and the like of the carrier wave of carrying the content information.

(1-2-3) Operation Principle of Score Addition Device

Next, with reference to FIG. 2, an explanation will be given on the operation principle of the recommendation device in the embodiment, in particular, the operation principle of the score addition device. FIG. 2 is a table showing a relationship between the attribute information and the operation history information for setting a recommended recording mode in each attribute in an initial state.

In particular, in the embodiment, before the i-th content information is recorded, the preferable recording mode, which is preferable for the user, of the i-th content information is specified by the recommendation device 150, on the basis of the attribute information and the operation history information associated with the (i−1)-th and previous content information (i.e. prior to the i-th information, including the (i−1)-th information). In order to specify the preferable recording mode (i.e. recommended recording mode), the score addition device 152 included in the recommendation device 150 adds a score, which indicates the degree of preferableness it is for the user, to the attribute information and the operation history information. The addition of the score is performed by managing a table as shown in FIG. 2. Incidentally, the recommendation device 150 can obtain the attribute information and the operation history information by referring to the attribute information memory device 141 and the operation history memory device 142.

As shown in FIG. 2, the user's operation history information and the recommended recording mode are stored in each of the four types of broadcast, which are terrestrial analog broadcast, BS analog broadcast, BS/CS digital broadcast and terrestrial digital broadcast, i.e. in each attribute information.

As the operation history information, the score is stored in an item of “recording”, an item of “recording mode setting change” and an item of “dubbing, move, etc.” as a positive element, and an item of “unperformed operation over a certain period” and an item of “deletion” as a negative element. The “positive element” herein means an operation which indicates that the user prefers the set recording mode. For example, under the premise that the recording mode set when the user performs recording, dubbing, move, etc., is the recording mode that the user prefers, the score is stored in the “recording mode setting change” and the “dubbing, move, etc.” as the “positive element”. The “negative element” herein means an operation which indicates that the user does not prefer the set recording mode. For example, under the premise that the user leaves contents, which were recorded in the past, unoperated over a certain period or deletes the contents because the user does not prefer the recording mode, the score is stored in the “unperformed operation over a certain period” and the “deletion” as the “negative element”.

With respect to the operation history information, i.e. the user's operation, the score is added which indicates the degree of preferableness it is for the user in each broadcast type. Incidentally, since FIG. 2 shows the relationship between the attribute information and the operation history information in the initial state, any item of the operation history information has a score of 0 points which indicates unperformed.

An item of “recommended recording mode” in FIG. 2 indicates a recommended recording mode in each broadcast type. The user performs the determination operation associated with the determination of the recording mode in accordance with or against the recommended recording mode.

As items of setting the recommended recording mode, there are items 11, 21, 31, and 41 associated with the type of the second recording medium, items 12, 22, 32, and 42 associated with the type of a transmission system, items 13, 23, 33, and 43 associated with the resolution, and items 14, 24, 34, and 44 associated with the image quality.

In particular, in the embodiment, the recommended recording mode in the initial state is specified or set in each broadcast type. Thus, the user can record the content information in the preferable recording mode according to the broadcast type. For example, as shown in FIG. 2, if the content information is obtained from a HD broadcast in terrestrial digital broadcast, the preferable recording mode is set on the basis of the fact that a Blu-ray disc, which does not need the format conversion in the recording, is preferable as the second recording medium 121 (refer to the item 41 associated with the type of the second recording medium, in FIG. 2). At this time, high-speed processing becomes possible when the recording is performed from the first recording medium 111 to the second recording medium 121 in the specified recording mode, which reduces a time required for the recording. Moreover, high-definition video images by the HD broadcast can be recorded.

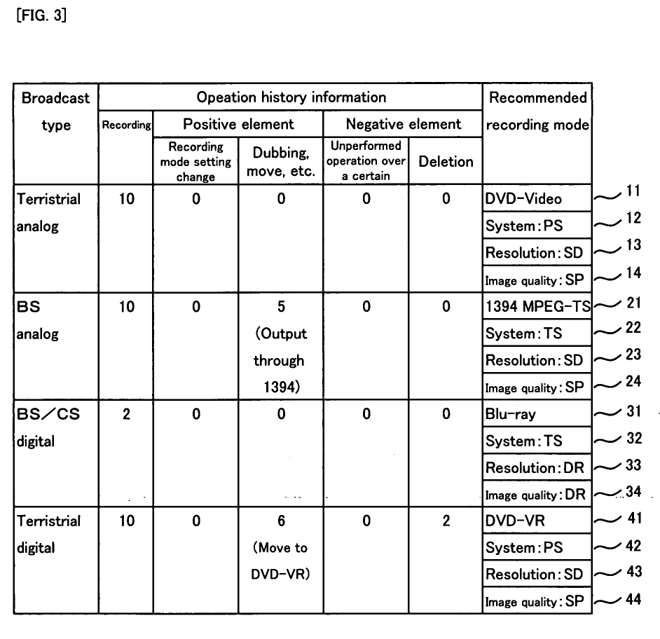

Next, with reference to FIG. 3, the operation principle of the score addition device will be detailed. FIG. 3 is a table having the same concept as that of FIG. 2 after a plurality of times of user's operations are performed.

As shown in FIG. 3, under the premise that the more strongly the user prefers a certain broadcast type, the more frequently the broadcast type is determined, the score is added to the broadcast type in accordance with the number of times that the content information in the broadcast type is recorded. For example, in FIG. 3, a score of “10 points” is added to the “recording” corresponding to “terrestrial analog” in FIG. 3. This indicates that the content information in the terrestrial analog broadcast is recorded ten times onto the first recording medium 111.

Moreover, under the premise that the more strongly the user prefers a certain recording mode, the more frequently the content information recorded in the recording mode is further recorded (i.e. copied, dubbed, moved, etc.) later, the score is added to the setting of the recording mode, in accordance with the number of times that the content information is further recorded later. At this time, in particular, the score is added in each type of the second recording medium 121 which is a recording output destination. For example, in FIG. 3, a score of “5 points (output through 1394)” is added to the “dubbing, move, etc.” corresponding to “BS analog”. This indicates that the content information in the BS analog broadcast, which is already recorded, is outputted five times through a data communication port in the IEEE 1394 standard. In the same manner, a score of “6 points (move to DVD-VR)” is added to the “dubbing, move, etc.” corresponding to “terrestrial digital”. This indicates that the content information in the terrestrial digital broadcast, which is already recorded, is moved six times to a DVD-VR. On the other hand, no score is added to either the “recording mode setting change” or “dubbing, move, etc.” corresponding to “terrestrial analog”, and both have 0 points. This indicates that after the recording is performed on the first recording medium 111 in the recommended recording mode, the recording operation (i.e. copy, dubbing, move, etc.) is not performed. In the same manner, no score is added to either the “recording mode setting change” or “dubbing, move, etc.” corresponding to “BS/CS digital”, and both have 0 points. This indicates that after the recording is performed on the first recording medium 111 in the recommended recording mode, the recording is not performed.

In the embodiment, in particular, the recording mode with a score of 5 points or more added is specified or set as the recommended recording mode under the premise that it is the recording mode that the user strongly prefers. That is, as shown in FIG. 2 and FIG. 3, in the “recommended recording mode” corresponding to “BS analog”, the item 21 associated with the type of the second recording medium is changed from “DVD-Video” (refer to FIG. 2) to “1394 MPEG-TS” (refer to FIG. 3), and the item 22 associated with the transmission system is changed from “PS” (refer to FIG. 2) to “TS” (refer to FIG. 3). In the same manner, in the “recommended recording mode” corresponding to “terrestrial digital”, the item 41 associated with the type of the second recording medium is changed from “Blu-ray disc” (refer to FIG. 2) to “DVD-VR” (refer to FIG. 3), and the item 42 associated with the transmission system is changed from “TS” (refer to FIG. 2) to “PS” (refer to FIG. 3), and the item 43 associated with the resolution is changed from “DR” (refer to FIG. 2) to “SD” (refer to FIG. 3), and the item 44 associated with the image quality is changed from “DR” (refer to FIG. 2) to “SD” (refer to FIG. 3). Thus, the user does not have to perform the operation of setting “1394 MPEG-TG” as the second recording medium and “TS” as the transmission system when BS analog broadcast is recorded next. In the same manner, the user does not have to perform the operation of setting “DVD-VR” as the second recording medium and “TS” as the transmission system when terrestrial digital broadcast is recorded next. That is, it is possible to recommend the recording mode suitable for the user's preference in the recording reservation, and it is further possible to reduce the user's operation load. At this time, in particular, the recording onto the first recording medium 111 is performed in the recording mode that is eventually the same as that in the recording (i.e. copy, dubbing, move, etc.) onto the second recording medium 121 which is expected to be performed later. Thus, the format conversion is unnecessary in the recording. Thus, high-speed processing becomes possible when the recording is performed from the first recording medium 111 to the second recording medium 121, which reduces a time required for the recording. For example, when the recording is performed from the first recording medium 111 to the second recording medium 121, high-speed processing like a several-ten-time speed.

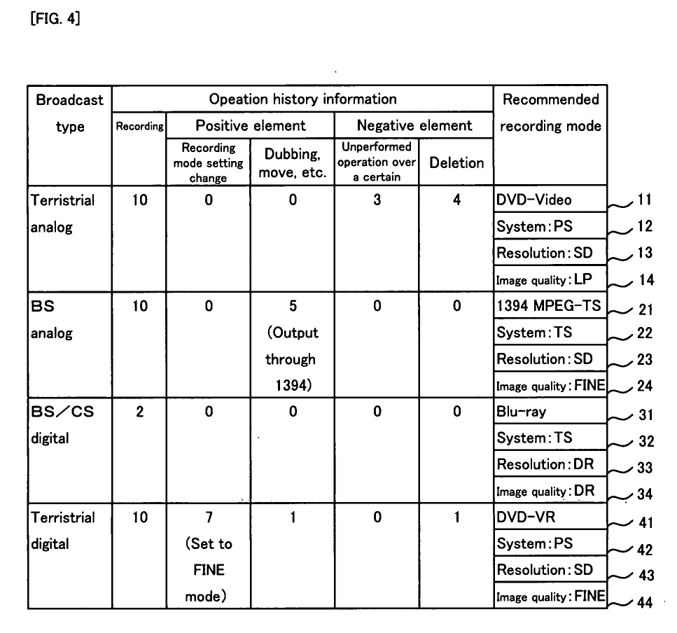

Next, with reference to FIG. 4, the principle of the score addition will be further explained. FIG. 4 is a table having the same concept as that of FIG. 3 after a plurality of times of user's operations are further performed from the condition in FIG. 3.

As shown in FIG. 4, particularly in the embodiment, under the premise that the more strongly the user prefers certain image quality, which is one of the items of setting the recording mode, the more frequently the image quality is determined, the score is added to the point to the image quality in accordance with the number of times that the content information is recorded in the image quality. In FIG. 4, a score of “7 points (set to FINE mode)” is added to the “recording mode setting change” corresponding to “terrestrial digital”. This indicates that the user changes the setting of the image quality to “FINE” seven times, against the image quality “SP” recommended as the recommended recording mode, when the content information in the terrestrial broadcast is recorded.

In the embodiment, in particular, the “image quality” with a point of five points or more added, which is the item of setting the recording mode, is set as the recommended recording mode under the premise that it is the image quality the user prefers. That is, as shown in FIG. 3 and FIG. 4, in the “recommended recording mode” corresponding to “terrestrial digital”, the item 44 associated with the image quality is change from “SP” (refer to FIG. 3) to “FINE” (refer to FIG. 4). Thus, the user does not have to perform the operation of setting “FINE” as the “image quality when the terrestrial digital broadcast is recorded next. That is, it is possible to recommend the recording mode suitable for the user's preference in the recording reservation, and it is further possible to reduce the user's operation load.

Moreover, as shown in FIG. 4, particularly in the embodiment, under the premise that the more weakly the user prefers a certain recording mode, the less frequently the content information recorded in the recording mode is further recorded (i.e. copied, dubbed, moved, etc.) or the more frequently it is deleted, the score is added to the broadcast type in accordance with the number of the content information that is not further recorded later over a certain period or that is deleted. That is, in FIG. 4, a score of “3 points” is added to the “unperformed operation over a certain period” corresponding to “terrestrial digital”. This indicates that there is an unoperated period three times longer than a predetermined period with regard to the content information in the terrestrial digital broadcast recorded in the previous recommended recording mode (refer to FIG. 3). Moreover, in FIG. 4, a score of “4 points” is added to the “deletion” corresponding to “terrestrial digital”. This indicates that four pieces of the content information in the terrestrial digital broadcast recorded in the previous recording mode (refer to FIG. 3) are deleted. In the embodiment, in particular, the score is added by using the operation which is expected to indicate that the user's preference for the recording mode is weak as the “negative element” operation. Then, if the total score added as the negative element operation is 7 points or more, the recommended recording mode is changed. That is, the score is added by using the “unperformed operation over a certain period” and the “deletion” as the “negative element” operation, and the total score added to the “negative element” operation corresponding to “terrestrial digital” is 7 points, so that the recommended recording mode is changed. Specifically, in order to save the recording capacity of a hard disk, which is the first recording medium 111, in FIG. 4, the recommended recording mode corresponding to “terrestrial analog” is changed from “image quality: SP” to “image quality: LP”. Incidentally, the “image quality: SP” means the recording in standard image quality, and the “image quality: LP” means the recording in low image quality.

The score added in this manner reflects the user's preference. Thus, the recording mode suited for the user's preference on the basis of the score can be recommended by the recommendation device 150.

Incidentally, in the embodiment, the user's operation is classified into the “positive element” and the “negative element”, and the “recording mode setting change” and the “dubbing, move, etc.” are set as the “positive element”, and the “unperformed operation over a certain period” and the “deletion” are set as the “negative element”. However, the user's operation may not be classified in this manner.

(1-2-4) Details of Operation History Information

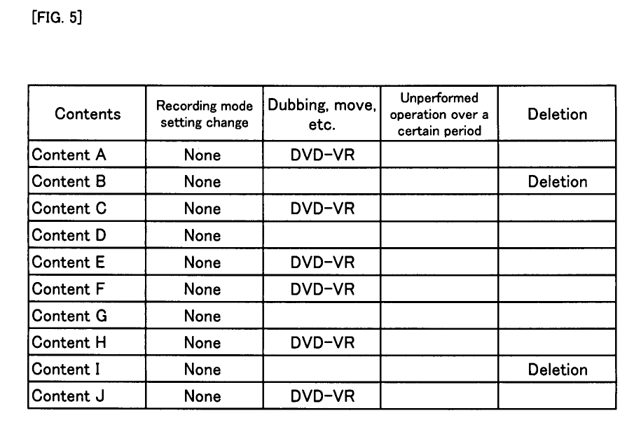

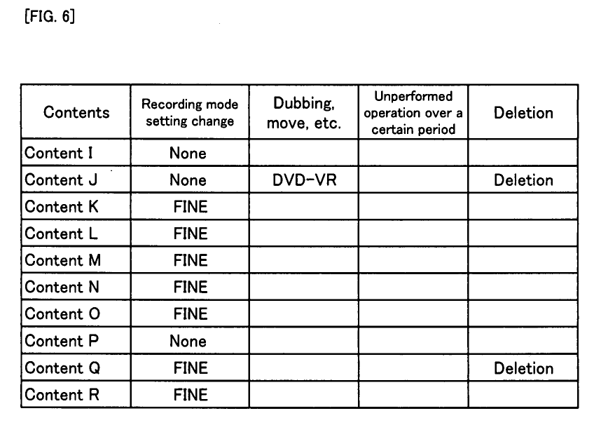

Next, with reference to FIG. 5 and FIG. 6, the operation history information will be detailed. FIG. 5 is a table showing the operation history information corresponding to FIG. 3, in the terrestrial digital broadcast. FIG. 6 is a table showing the operation history information corresponding to FIG. 4, in the terrestrial digital broadcast.

As shown in FIG. 5, the operation history information about information contents in the terrestrial digital broadcast is stored in each of the content information. It indicates that a content A to a content J are recorded in order onto the first recording medium 111. The operations shown in FIG. 5 (i.e. “recording mode setting change”, “dubbing, move, etc.”, “unperformed operation over a certain period”, and “deletion”) correspond to the operations shown in FIG. 3. That is, FIG. 5 shows, as in FIG. 3, that the content information in the terrestrial digital broadcast is recorded ten times (i.e. ten contents from the contents A to J) without the recording mode setting change and that the recorded content information is recorded (i.e. copied, dubbed, moved, etc.) six times (i.e. six contents of the contents A, C, E, F, H, and J) onto a DVD-VR and it is deleted twice (i.e. two contents of the contents C and I).

FIG. 6 shows the operation history information corresponding to FIG. 4. That is, FIG. 6 shows, as in FIG. 4, that the content information in the terrestrial digital broadcast is recorded three times (i.e. three contents of the contents I, J, and P) without the recording mode setting change and that the setting of the recording mode is changed to the FINE mode (i.e. the highest image quality in SD (standard resolution) and then recorded seven times (i.e. seven contents of the contents K to O, Q, and R). Moreover, FIG. 6 shows, as in FIG. 4, that the recorded content information is recorded (copied, dubbed, moved, etc.) once (i.e. one content information J) onto a DVD-VR and it is deleted once (i.e. the content I), with regard to the content information in the terrestrial digital broadcast.

As described above with reference to FIG. 3, in the embodiment, under the premise that the more strongly the user prefers a certain recording mode, the more frequently the recording mode is determined, the score is added to the recording mode in accordance with the number of times that the recording is performed in the recording mode. Then, the recording mode with a score of 5 points or more added is set as the recommended recording mode under the premise that it is the recording mode that the user strongly prefers.

Moreover, in the embodiment, in particular, the recording mode which is relatively highly frequently determined in the determination operations which were performed ten times in the past is considered to be the preferable recording mode. That is, the determination operation, which is a score-added target, as described above, is limited to the determination operations which were performed ten times in the past, as shown in FIG. 5 and FIG. 6. Thus, regardless of the determination operation that the user preferably performed before the ten times of operations, it is possible to specify the recording mode suitable for the user's preference in the last ten times of determination operations. That is, the recording mode suitable for the user's preference, which can be changed with the course of time, can be set as the preferable recording mode. Thus, the recording mode preferable for the user can be recommended to the user, almost certainly. Incidentally, the number of times which goes back to the past may be changed as long as a memory or the like provided for the operation history memory device allows it. However, it is not realistic to leave the operation history for e.g. 10,000 times of recording to set the recording mode.

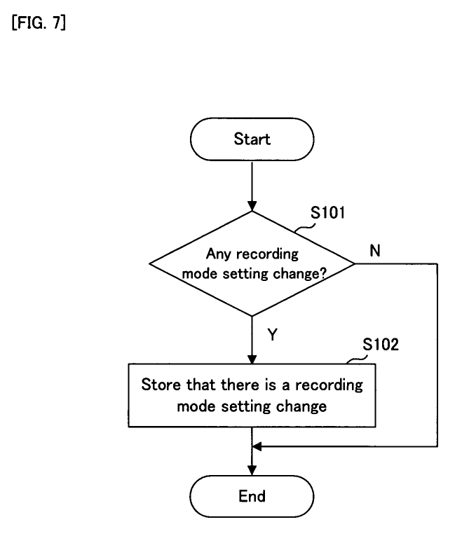

Next, with reference to FIG. 7, an explanation will be given on a change in the operation history information associated with the recording mode setting change. FIG. 7 is a flowchart showing the change in the operation history information associated with the recording mode setting change.

As shown in FIG. 7, after the content information is recorded, firstly, it is confirmed whether there is the recording mode setting change (step S101).

If there is the recording mode setting change (the step S101: Y), the operation history information is stored or changed by the operation history memory device 142, as shown in the aforementioned FIG. 5 and FIG. 6 (or FIG. 2 to FIG. 4) (step S102).

If there is not the recording mode setting change (the step S101: N), the operation history information is not changed and maintained as it is.

The operation associated with the recording mode setting change as described above is preformed, regularly or irregularly, as a sub-routine during power-on.

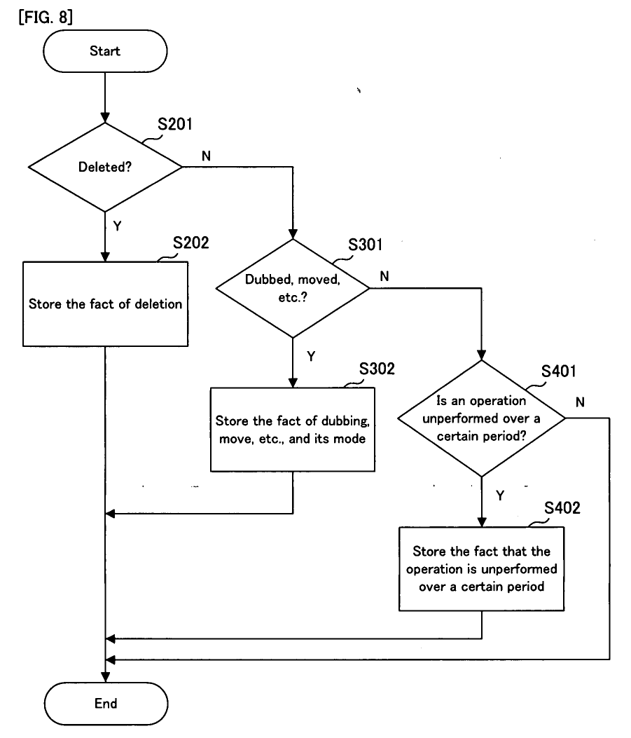

Next, with reference to FIG. 8, an explanation will be given on a change in the operation history information associated with the deletion of the content information, the dubbing, move, etc., and the unperformed operation over a certain period. FIG. 8 is a flowchart showing the change in the operation history information associated with the deletion of the content information, the dubbing, move, etc. and the unperformed operation over a certain period.

As shown in FIG. 8, if the confirmation of the operation performed on the content information is started, firstly, it is confirmed whether the content information is deleted (step S201). Such confirmation is performed by monitoring whether an input operation to delete it is performed, or by monitoring the deletion of information in a file system, for example.

If the content information is deleted (the step S201: Y), the fact of deletion is stored as the operation history information, as shown in the aforementioned FIG. 5 and FIG. 6 (or FIG. 2 to FIG. 4).

If the content information is not deleted (the step S201: N), it is confirmed whether the content information is recorded (or copied, dubbed, moved, etc.) (step S301).

If the content information is recorded on the second recording medium 121 (the step S301: Y), the fact of recording and its recording mode are stored as the operation history information, as shown in the aforementioned FIG. 5 and FIG. 6 (or FIG. 2 to FIG. 4) (step S302).

If the content information is recorded on the second recording medium 121 (the step S301: N), it is confirmed whether an operation is unperformed over a certain period on the content information (step S401). Here, the certain period may be used, for example, a period of 1 month, 3 months, 6 months, or the like, as initial setting, or it may be set or changed by the user.

If an operation is unperformed over a certain period on the content information (the step S401: Y), the fact that the operation is unperformed over a certain period is stored as the operation history information, as shown in the aforementioned FIG. 5 and FIG. 6 (or FIG. 2 to FIG. 4) (step S402).

If an operation is not unperformed over a certain period on the content information (the step S401: N), the operation history information is not changed and is maintained as it is.

(1-2-5) Specification of Recommended Recording Mode

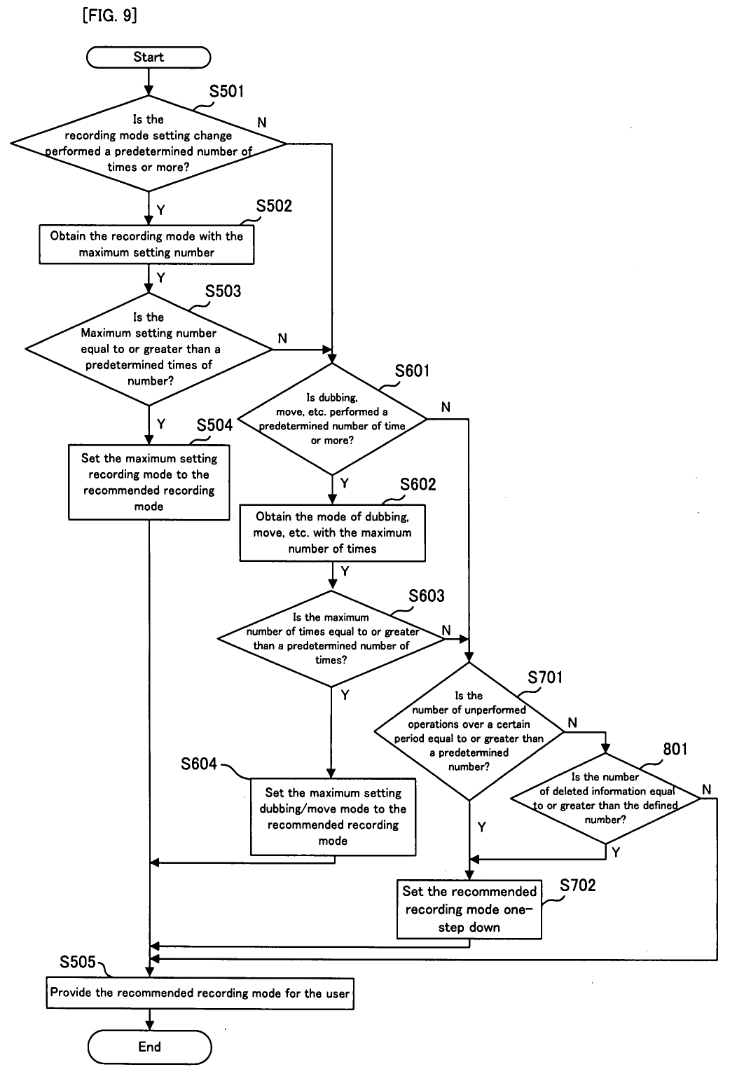

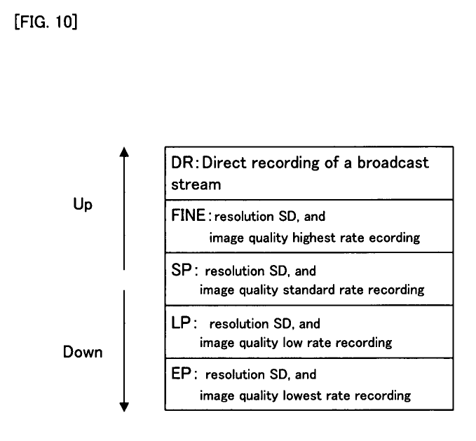

Next, with reference to FIG. 9 and FIG. 10, the specification of the recommended recording mode will be detailed. FIG. 9 is a flowchart showing a flow of specification of the recommendation recording mode. FIG. 10 is a diagram showing image quality setting types. Incidentally, the same is true for the case that the recording of terrestrial analog broadcast, BS analog broadcast, or BS/CS digital broadcast is specified.

As shown in FIG. 9, in the recording reservation, if the recording of terrestrial digital broadcast is specified by the user's operation, the specification of the recommended recording mode is started by the recommendation device 150.

Firstly, it is judged by the recommendation device 150 whether or not the recording mode setting change, i.e. the recording in a different recording mode from the one that is already recommended to the user as the recommended recording mode, is performed a predetermined number of times or more (step S501).

If the recording mode setting change is performed a predetermined number of times or more (the step S501: Y), the recording mode with the maximum number of the setting by the setting change (hereinafter referred to as a “maximum setting recording mode”) is stored together with the number of times of the setting (hereinafter referred to as the “maximum setting number”) (step S502). Here, the predetermined number of times is three times in the embodiment; however, another number of times is also possible. However, the last ten times of determination operations (i.e. the recording mode) are stored as the operation history information, as described above. Thus, there are expected two or three types of the recording modes whose predetermined number of times is three times. In such a case, the latest recording mode which reaches the third time may be stored as the maximum setting recording mode. By this, it is possible to set the recording mode which reflects the user's preference of later date, as the recommended recording mode.

Then, it is judged by the recommendation device 150 whether the maximum setting number is equal to or greater than a predetermined number of times (step S503).

If the maximum setting number is equal to or greater than a predetermined number of times (the step S503: Y), the maximum setting recording mode is set as the recommended recording mode (step S504).

On the other hand, if the recording mode setting change is not performed a predetermined number of times or more (the step S501: N), or if the maximum setting number is less than a predetermined number of times (the step S503: N), it is judged by the recommendation device 150 whether the recording (or copying, dubbing, move, etc.) onto the second recording medium 121 is further performed a predetermined number of times or more, on the content information recorded on the first recording medium 111 from the terrestrial digital broadcast (step S601).

If the recording (or copying, dubbing, move, etc.) onto the second recording medium 121 is performed a predetermined number of times or more (the step S601: Y), the recording mode with the maximum number of the setting upon the recording (or copying, dubbing, move, etc.) (hereinafter referred to as a “maximum setting dubbing/move mode”) is stored together with the number of times (hereinafter referred to as the “maximum number of times”) (step S602). Here, the predetermined number of times is three times in the embodiment; however, another number of times is also possible. However, the last ten times of determination operations (i.e. the recording mode) are stored as the operation history information, as described above. Thus, there are expected two or three types of the recording modes whose predetermined number of times is three times. In such a case, the latest recording mode which reaches the third time may be stored as the maximum setting recording mode. By this, it is possible to set the recording mode which reflects the user's preference of later date, as the recommended recording mode.

Then, it is judged by the recommendation device 150 whether the maximum number of times is equal to or greater than a predetermined number of times (step S603).

If the maximum number of times is equal to or greater than a predetermined number of times (the step S603: Y), the maximum setting dubbing/move mode is set as the recommended recording mode (step S604).

On the other hand, if the recording (or copying, dubbing, move, etc.) onto the second recording medium 121 is not performed a predetermined number of times or more (the step S601: N), or if the maximum number of times is less than a predetermined number of times (the step S603: N), it is confirmed whether there are a predetermined number or more of content information that is unoperated over a certain period, from among the content information recorded onto the first recording medium 111 from the terrestrial digital broadcast (step S701).

If there are a predetermined number or more of content information that is unoperated over a certain period (the step S701: Y), the image quality is set one-step down in order to save the recording capacity of a hard disk, which is the first recording medium 111, as described above with reference to FIG. 4, in the recommended recording mode which is already set; namely, a low-image-quality recording mode which can save the recording capacity is set as the recommended recording mode (step S702). As shown in FIG. 10, the setting of the image quality includes, from high image quality to low image quality, “DR”, “FINE”, “SP”, “LP”, and “EP”. “Setting the image quality one-step down” in the embodiment indicates changing the setting to the image quality adjacent in an arrow (down) direction in FIG. 10. “Setting the image quality one-step up” indicates changing the setting to the image quality adjacent in an arrow (up) direction in FIG. 10.

On the other hand, if there are not a predetermined number or more of content information that is unoperated over a certain period (the step S701: N), it is judged by the recommendation device 150 whether there are a predetermined number or more of the deleted content information, from among the content information recorded onto the first recording medium 111 from the terrestrial digital broadcast (step S801).

If there are a predetermined number or more of the deleted content information (the step S801: Y), as in the case that there are a predetermined number or more of content information that is unoperated over a certain period (the step S701: Y), the image quality is set one-step down in the recommended recording mode that is already set (the step S702).

If there are not a predetermined number or more of the deleted content information (the step S801: N), the recommended recording mode that is already set is maintained as it is.

The recommended recording mode set as described above is recommended by the recommendation device 150 to the user, for example, in the recording reservation (step S505). That is, by displaying the information which induces the use of the specified recording mode, on the display screen of the display apparatus 200, the information which indicates the above is visually provided for the user.

As a result, the larger number of times the user performs the operation, i.e. the more frequently the user uses the recording/reproducing apparatus 10, the more preferable, based on the user, recording mode of the content information can be recommended. The user does not have to set the recording mode of the content information in each time of recording from the beginning. That is, in accordance with the recommendation by the recommendation device 150, the operation of setting the recording mode is hardly performed, or a load related to the setting operation is reduced. In this manner, usability increases, and it is possible to reduce the load on the user's operation like, for example, that the recording mode is to be changed every time by the user's operation. At this time, in particular, the recording onto the first recording medium 111 is performed in the recording mode that is eventually the same as that in the recording (i.e. copy, dubbing, move, etc.) onto the second recording medium which is expected to be performed later. Thus, the format conversion is unnecessary in the recording. Thus, high-speed processing becomes possible when the recording is performed from the first recording medium 111 to the second recording medium 121, which reduces a time required for the recording. For example, if the format conversion is necessary when the recording is performed from the first recording medium 111 to the second recording medium 121, a one-time speed to a several-time speed are the limit of high-speed processing; however, if the format conversion is unnecessary, a several-ten-time speed of high-speed processing is possible.

(1-2-6) Recording Reservation Screen

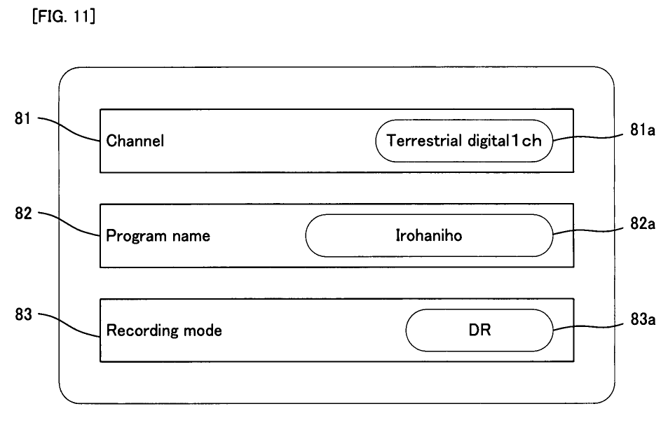

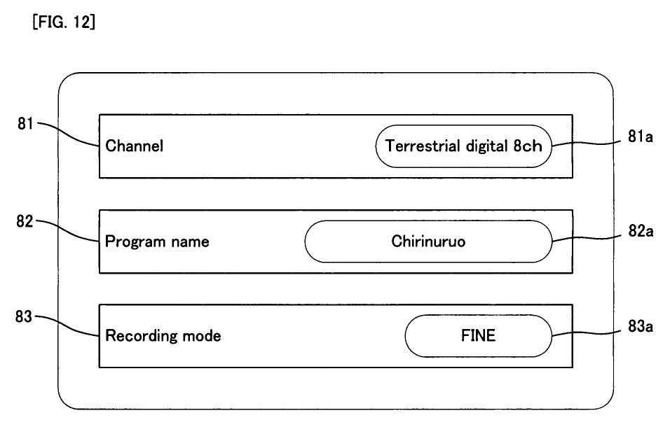

Next, with reference to FIG. 2, FIG. 3, FIG. 11, and FIG. 12, a recording reservation screen will be explained. FIG. 11 is a schematic diagram showing the recording reservation screen when the terrestrial digital broadcast is recorded in the condition of FIG. 2. FIG. 12 is a schematic diagram having the same concept as that of FIG. 11 in the condition of FIG. 3.

As shown in FIG. 11, the recording reservation screen has: a channel column 81; a program name column 82; a recording mode column 83.

The channel column 81 displays a channel (including the broadcast type) of the content information that the user are going to record. The channel that is going to be recorded is inputted by the user. FIG. 11 shows that the content information of a channel “terrestrial digital 1ch” (numerical reference 81a) is going to be inputted.

The program name column 82 displays a program name of the content information the user are going to record. The program name that is going to be recorded is inputted by the user. FIG. 11 shows that the content information of a program name “Irohaniho” (numerical reference 82a) is going to be inputted.

The recording mode column 83 displays the recommended recording mode when the user determines the channel and the program name to be recorded. FIG. 11 shows the recommended recording mode in the state of FIG. 2, i.e. in the initial state, and the recording mode “DR” (numerical reference 83a) is displayed in the recording mode column 83.

As shown in FIG. 12, in the state of FIG. 3, i.e. after the recommended recording mode is changed, if the user sets the channel “terrestrial digital 8ch” (numerical reference 81a) whose broadcast type is terrestrial digital broadcast, the recommended recording mode corresponding to the terrestrial digital in FIG. 3, i.e. “FINE” (numerical reference 83a) is displayed in the recording mode column 83. Moreover, the user can also change the recording mode.

### Second Embodiment

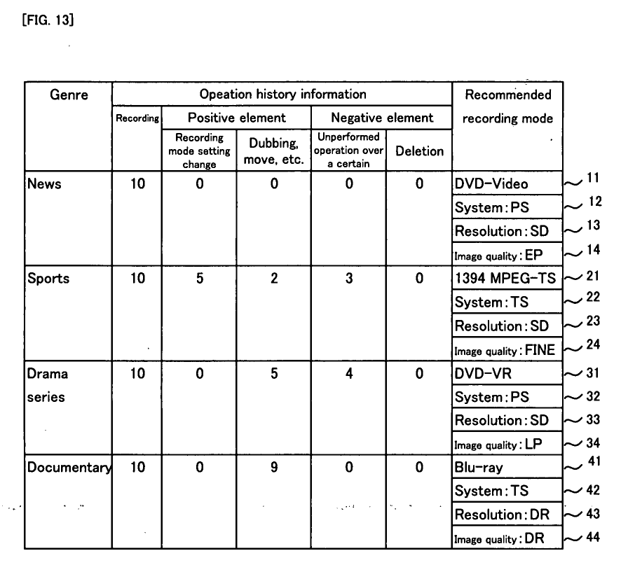

Next, with reference to FIG. 13, an explanation will be given on a recording/reproducing apparatus in a second embodiment in the present invention. FIG. 13 is a table having the same concept as that of FIG. 3 in the second embodiment. In FIG. 13, the same constituent elements as those in the first embodiment shown in FIG. 3 carry the same numerical references, and the explanation thereof will be omitted.

As shown in FIG. 13, in the second embodiment, the user's operation history is stored in each genre of four types of content information, which are news, sports, drama series, and documentary.

In each genre, the “recording”, the “recording mode setting change”, the “dubbing, move, etc.”, the “unperformed operation over a certain period”, and the “deletion” are stored as the operation history. To the operation history information, i.e. the user's operation, the score, which indicates the degree of preferableness it is (or how much it is preferable) for the user, is added in each genre of the content information. Thus, as in the recording/reproducing apparatus in the first embodiment, it is possible to recommend the recording mode that the user prefers in each attribute information, i.e. in each genre in the second embodiment. At this time, in particular, the recording onto the first recording medium 111 is performed in the recording mode that is eventually the same as that in the recording (i.e. copy, dubbing, move, etc.) onto the second recording medium 121 which is expected to be performed later. Thus, the format conversion is unnecessary in the recording. Thus, high-speed processing becomes possible when the recording is performed from the first recording medium 111 to the second recording medium 121, which reduces a time required for the recording. For example, if the format conversion is necessary when the recording is performed from the first recording medium 111 to the second recording medium 121, a one-time speed to a several-time speed are the limit of high-speed processing; however, if the format conversion is unnecessary, a several-ten-time speed of high-speed processing is possible.

The present invention is not limited to the aforementioned embodiments, and various changes may be made without departing from the essence or spirit of the invention which can be read from the claims and the entire specification. A recording/reproducing apparatus, which involves such changes, is also intended to be within the technical scope of the present invention.

As explained above in details, according to the recording/reproducing apparatus in the embodiments, it is provided with: the recommendation device 150, so that it is possible to specify the recording mode that is preferable for the user and to recommend the specified recording mode to the user, on the basis of the attribute information and the operation history information.

### INDUSTRIAL APPLICABILITY

The recording/reproducing apparatus according to the present invention can be applied to an information recording medium, such as a hard disk, a DVD, and a Blu-ray disc, and it can be further applied to a recording/reproducing apparatus which can record or reproduce the content information, such as a broadcast program, onto or from such an information recording medium.

1. A recording/reproducing apparatus comprising:
an attribute information memory device for storing attribute information which indicates an attribute corresponding to i-th content information to be recorded (wherein i is a natural number);
an operation history memory device for storing operation history information which indicates a history of determination operations related to a user's determination of a recording mode, which is performed on the i-th content information;
a recommending device for specifying a recording mode, which is preferable for the user, of the i-th content information and recommending the specified recording mode to the user, on the basis of the attribute information and the operation history information related to the (i−1)-th and previous content information before the i-th content information is recorded;
a first recording device for recording the i-th content information onto the first recording medium in the recording mode determined by the determination operation by the user in accordance with or against the recommended recording mode;
a second recording device for recording the recorded content information in the determined recording mode from the first recording medium to the second recording medium; and
a reproducing device for reproducing the content information recorded on the first or second recording medium.

2. The recording/reproducing apparatus according to claim 1, wherein said recommending device specifies the preferable recording mode in each attribute.

3. The recording/reproducing apparatus according to claim 1, wherein said recommending device specifies the recording mode which is relatively highly frequently determined in the determination operations, as the preferable recording mode in each attribute.

4. The recording/reproducing apparatus according to claim 1, wherein said recommending device specifies the recording mode which is relatively highly frequently determined in the determination operations which were performed the predetermined number of times in the past from the i-th determination operation, as the preferable recording mode.

5. The recording/reproducing apparatus according to claim 1, wherein said recommending device includes a score adding device for adding a score which indicates degrees of preferableness it is for the user, to at least one of the attribute information and the operation history information.

6. The recording/reproducing apparatus according to claim 1, further comprising a determining device which can determine the recording mode through the determination operations by the user,
said first recording device recording the i-th content information onto the first recording medium in the recording mode determined through said determining device,
said second recording device recording the i-th content information onto the second recording medium in the recording mode determined through said determining device.

7. The recording/reproducing apparatus according to claim 1, wherein said attribute information memory device stores an input form of the inputted content information, as the attribute information.

8. The recording/reproducing apparatus according to claim 1, wherein said attribute information memory device stores genre to which the inputted content information belongs, as the attribute information.

9. The recording/reproducing apparatus according to claim 1, wherein said operation history memory device stores a change operation of the recommended recording mode, as the operation history information.

10. A recording/reproducing apparatus on which content information recorded on a first recording medium can be recorded in a desired recording mode by a second recording device which can perform recording from the first recording medium to a second recording medium, said recording/reproducing apparatus comprising:
an attribute information memory device for storing attribute information which indicates an attribute corresponding to i-th content information to be recorded (wherein i is a natural number);
an operation history memory device for storing operation history information which indicates a history of determination operations related to a user's determination of a recording mode, which is performed on the i-th content information;
a recommending device for specifying a recording mode of the i-th content information, which is preferable for the user, and recommending the specified recording mode to the user, on the basis of the attribute information and the operation history information related to the (i−1)-th and previous content information before the i-th content information is recorded;
a first recording device for recording the i-th content information onto the first recording medium in the recording mode determined by the determination operation by the user in accordance with or against the recommended recording mode; and
a reproducing device for reproducing the content information recorded on the first recording medium.
